(19) United States
(12) Patent Application Publication
(10) Pub. No.: US 2016/0267499 A1
(43) Pub. Date: Sep. 15, 2016

(54) WEBSITE PERSONALIZATION BASED ON REAL-TIME VISITOR BEHAVIOR

(71) Applicant: NEEDLE, INC., Bluffdale, UT (US)

(72) Inventor: Mikko Tapio Valimaki, Orem, UT (US)

(21) Appl. No.: 15/001,081

(22) Filed: Jan. 19, 2016

Related U.S. Application Data
(63) Continuation of application No. 14/312,403, filed on Jun. 23, 2014.
(60) Provisional application No. 61/838,800, filed on Jun. 24, 2013.

(51) Int. Cl. G06Q 30/02; G06Q 30/06

(52) U.S. Cl. CPC G06Q 30/0201; G06Q 30/0613

(57) ABSTRACT

Website personalization based on real-time visitor behavior. In one example embodiment, a method of website personalization based on real-time visitor behavior may include tracking real-time behavior of a visitor on a website during a visit to the website where the visitor employs a computing device to visit the website. The method may further include assigning the visit to one of multiple visit-based segments based on the tracked real-time behavior of the visitor and without regard to any previous behavior of the visitor that occurred previous to the visit. The method may also include personalizing, by a web server that hosts the website, the website presented at the computing device during the visit based on the assigned visit-based segment by presenting a selectable webpage element on the website that invites the visitor to a chat conversation between a human agent of the website and the visitor.

### FIELD

The embodiments disclosed herein relate to website personalization based on real-time visitor behavior.

### BACKGROUND

Website personalization generally attempts to accommodate the differences between individual visitors to a website in order to make the website more relevant to each individual visitor. In particular, website personalization generally includes personalizing webpages of a website based on predetermined characteristics of a visitor. For example, when a visitor visits an online retailer web site, information regarding a visitor's gender, age, and past purchasing habits may be gathered and user to alter the content of a webpage on the online retailer website in an attempt to make the content more relevant to the visitor. In this manner, web site personalization attempts to focus or target webpage content to pre-gathered individual characteristics of a web site visitor.

One common problem associated with website personalization involves the ineffectiveness of personalization based on visitor characteristics that are not particularly relevant to the visitor's current intentions or needs. In particular, the relevance of pre-gathered characteristics of a website visitor may decrease rapidly over time. From the example above, information regarding past purchasing habits may not be relevant to a website visitor's current intentions while visiting the same online retailer website, as the visitor may be in need of a product that is entirely unrelated to products that the visitor purchased previously on the online retailer website. Therefore, the use of past purchasing habits in the personalization of the webpages of the online retailer website would not be helpful to the user as such website personalization would tend to point the user to products that the visitors does not currently need or want. Such website personalization can be distracting and frustrating to website visitors because it fails to account for the visitors' current needs and intentions for visiting the web site.

The subject matter claimed herein is not limited to embodiments that solve any disadvantages or that operate only in environments such as those described above. Rather, this background is only provided to illustrate one example technology area where some embodiments described herein may be practiced.

### SUMMARY

In general, example embodiments described herein relate to website personalization based on real-time visitor behavior. The example methods disclosed herein may be employed to track real-time behavior of a visitor to a website during a visit to the website. This tracked real-time behavior may then be the basis for assigning the visit to one of multiple segments and then personalizing the website during the visit based on the assigned segment. Unlike methods of segmentation that are visitor-based and tend to focus only on pre-gathered characteristics of a website visitor, the example methods disclosed herein are visit-based and focus instead on real-time behavior of the visitor during a particular visit. Visit-based dynamic segmentation tends to be more relevant and helpful to a website visitor that visitor-based segmentation because it accounts for the visitor's current needs and intentions during a particular visit to a website. Visit-based dynamic segmentation may also enable selective website personalization of multiple visitors exhibiting similar real-time behavior, such that the outcomes of the similar visits can be compared in order to measure the impact of the visit-based website personalization on a conversion event of the website.

In one example embodiment, a method of website personalization based on real-time visitor behavior may include tracking real-time behavior of a visitor on a website during a visit to the website where the visitor employs a computing device to visit the website. The method may further include assigning the visit to one of multiple visit-based segments based on the tracked real-time behavior of the visitor and without regard to any previous behavior of the visitor that occurred previous to the visit. The method may also include personalizing, by a web server that hosts the website, the website presented at the computing device during the visit based on the assigned visit-based segment by presenting a selectable webpage element on the website that invites the visitor to a chat conversation between a human agent of the website and the visitor.

In another example embodiment, a method of website personalization based on real-time visitor behavior may include tracking real-time behavior of a first visitor on a website during a visit to the website where the first visitor employs a first computing device to visit the website and tracking real-time behavior of a second visitor on the website during a visit to the website where the second visitor employs a second computing device to visit the website. The method may further include determining that the visit of the first visitor and the visit of the second visitor both correspond to a particular one of multiple segments based on the first visitor's tracked real-time behavior and the second visitor's tracked real-time behavior and without regard to any previous behavior of the first visitor that occurred previous to the visit of the first visitor and without regard to any previous behavior of the second visitor that occurred previous to the visit of the second visitor. The method may further include assigning the visit of the first visitor to a test group of the particular visit-based segment where the test group is targeted for website personalization and personalizing, by a web server that hosts the website, the website presented at the first computing device during the visit of the first visitor based on the particular visit-based segment by presenting a selectable webpage element on the website that invites the first visitor to a chat conversation between a human agent of the website and the first visitor. The method may also include assigning the visit of the second visitor to a control group of the particular visit-based segment where the control group is not targeted for website personalization and not personalizing, by the web server, the website presented at the second computing device during the visit of the second visitor by not presenting a selectable webpage element on the website that invites the second visitor to a chat conversation between a human agent of the website and the second visitor. The method may further include comparing outcomes of the visit of the first visitor and the visit of the second visitor to measure an impact of the website personalization on a conversion event of the website.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a schematic block diagram illustrating an example dynamic segmentation system;

FIGS. 2-5 are schematic flowchart diagrams of example methods of dynamic segmentation of website visits;

FIG. 6 is a chart illustrating various website segments;

FIGS. 7 and 8 illustrate example computer screen images of a user interface of an example dynamic segmentation system; and

FIG. 9 is a schematic flowchart diagram of an example method of dynamic segmentation of website visits.

### DESCRIPTION OF EMBODIMENTS

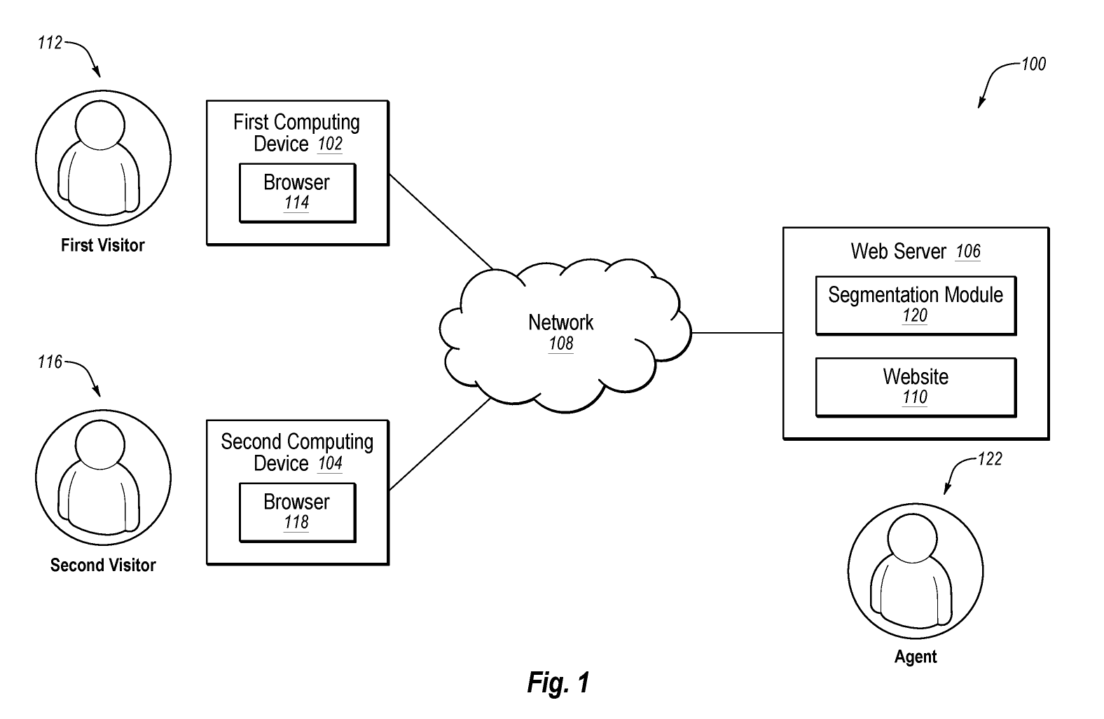

FIG. 1 is a schematic block diagram illustrating an example dynamic segmentation system 100. As disclosed in FIG. 1, the example system 100 includes a first computing device 102, a second computing device 104, and a web server 106. The first and second computing devices 102 and 104 are able to communicate with the web server 106 over a network 108. The web server 106 hosts a website 110. A first visitor 112 can employ a browser application 114 on the first computing device 102 to visit the website 110. Similarly, a second user 116 can employ a browser application 118 on the second computing device 102 to visit the website 110. A segmentation module 120 included on the web server 106 may be employed to dynamically segment the visits of the first visitor 112 and the second user 116 in order to personalize the website 110 for one or both visitors. The segmenting of visits to the website 110 may enable a determination as to whether a visit belongs to a segment that makes the visit a good candidate for expending the resources associated with personalizing the website 110 in order to encourage a conversion event on the website 110. This personalization may include, among other things, inviting the visitor to take a survey related to the website 110, presenting personalized advertisements to the visitor on the website 110, presenting personalized search results on the website 110, inviting the visitor to a chat conversation between the human agent 122 of the website 110 and the visitor, or some combination thereof. Additional details regarding chat conversations between visitors to a website and human agents of the website can be found in U.S. patent application Ser. Nos. 13/462,704 and 13/462,711, both filed on May 2, 2012, and both incorporated herein by reference in their entireties.

The first and second computing devices 102 and 104 may each be any computing device capable of executing a browser application and communicating over the network 108 with the webserver 106. For example, the first and second computing devices 102 and 104 may each be a physical computer such as a personal computer, a desktop computer, a laptop computer, a tablet computer, a handheld device, a multiprocessor system, a microprocessor-based or programmable consumer electronic device, a smartphone, or some combination thereof. The first and second computing devices 102 and 104 may each also be a virtual computer such as a virtual machine. The network 108 may be any wired or wireless communication network including, for example, a Local Area Network (LAN), a Metropolitan Area Network (MAN), a Wide Area Network (WAN), a Wireless Application Protocol (WAP) network, a Bluetooth® network, an Internet Protocol (IP) network such as the internet, or some combination thereof.

During performance of the example methods disclosed herein, the segmentation module 120 may track real-time behavior of the first and second visitors 112 and 116 during visits to the website 110 and then assign those visits to one of multiple segments based on the tracked real-time behavior. The tracked real-time behavior of a visitor may include, for example: page(s) of the website 110 interacted with by the visitor during the visit, how long each of the page(s) has focus during the visit, a number of tabs in the browser 114 or 118 that the visitor has open during the visit, interaction between the visitor and a shopping cart of the website 110, repeat interactions with page(s) of the website 110 during the visit, or some combination thereof. The website 110 may then be personalized for one or both visits based on the assigned segments, as discussed in greater detail below. In this manner, the example methods disclosed herein can employ visit-based dynamic segmentation to make the website 110 more relevant and helpful to a website visitor because the website 110 will be personalized to account for the visitor's current needs and intentions during a particular visit to the website 110.

In addition, where the first and second visitors 112 and 116 exhibit similar real-time behavior during their respective visits, and thus their visits are assigned to the same segment, only one of the visits may include a website personalization, as discussed in greater detail below. In this manner, the example methods disclosed herein can enable selective website personalization of multiple visitors exhibiting similar real-time behavior such that the outcomes of the similar visits can be compared in order to measure the impact of the website personalization on a conversion event of the website 110. Such a conversion event may include, for example: a sale of an item to a visitor, a subscription by a visitor, a donation by a visitor, submission of personal information by a visitor, or some combination thereof.

Although only a single web server 106 is disclosed in FIG. 1, it is understood that the website 110 may actually be hosted across multiple web servers. Further, although only two computing devices 102 and 104 are disclosed in FIG. 1, it is understood that the website 110 may actually be visited using any number of visitors using any number of different computing devices. Further, although the segmentation module 120 is the only module disclosed in the example system 100 of FIG. 1, it is understood that the functionality of the segmentation module 120 may be replaced or augmented by one or more similar modules residing on the computing device 102, the computing device 104, the web server 106, or another machine or system.

Having described one specific environment with respect to FIG. 1, it is understood that the specific environment of FIG. 1 is only one of countless environments in which the example methods disclosed herein may be practiced. The scope of the example embodiments is not intended to be limited to any particular environment.

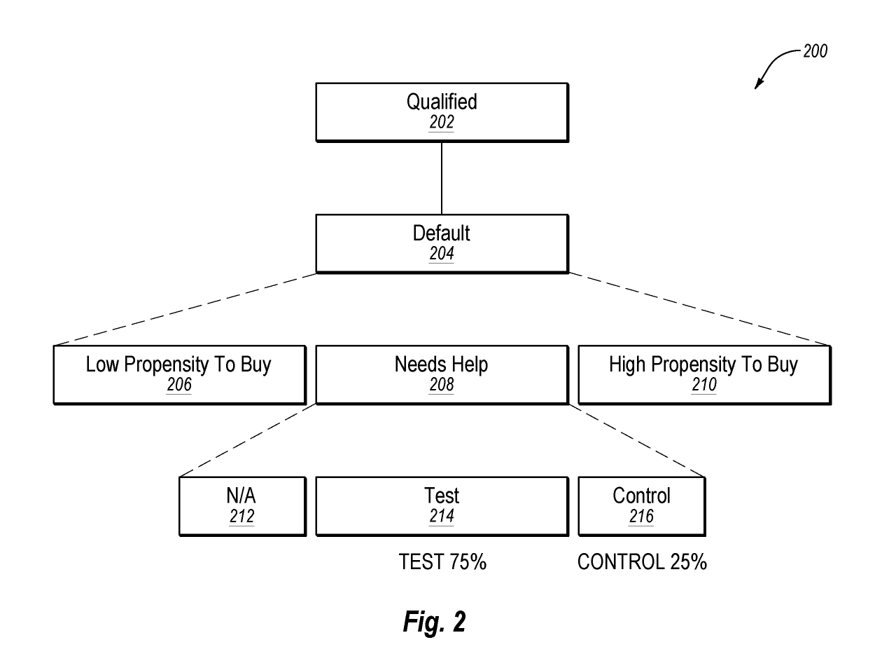

FIG. 2-5 are schematic flowchart diagrams of example methods 200, 300, 400, and 500, respectively, of dynamic segmentation of website visits. The methods 200, 300, 400, and 500 may be implemented, in at least some embodiments, by the segmentation module 120 of the example system 100 of FIG. 1. For example, the segmentation module 120 may be configured to execute computer instructions to perform operations of dynamic segmentation of visits to the website 110, as represented by one or more of steps of the methods 200, 300, 400, and 500. Although illustrated as discrete steps, various steps may be divided into additional steps, combined into fewer steps, or eliminated, depending on the desired implementation. The methods 200, 300, 400, and 500 will now be discussed with reference to FIGS. 1-5.

The method 200 disclosed in FIG. 2 is one example method of dynamic segmentation of website visits. The method 200 may include step 202 in which a visit to a website is qualified. For example, the first visitor 112 may employ the browser 114 on the first computing device 102 to visit the website 110. Upon visiting the website 110, the segmentation module 120 may, at step 202, qualify the visit. Qualifying the visit may include making a determination that the visit is considered a candidate for the segmentation and potential personalization on the website 110. This determination may depend on the computing device employed during the visit or the geographic location of the visitor during the visit. For example, the segmentation module 120 may be configured to only provide segmentation and potential personalization to visits where the visitor is using a laptop or desktop computers and located in the United States during the visit. For example, where the website 110 only allows shipping within the United States, it may not make sense to employ the segmentation and personalization disclosed herein during a visit in which the visitor is currently located outside of the United States, since any purchase of a product as a result of the segmentation and personalization could not be shipped by the website 110 to the visitor's current location.

The method 200 may next include step 204 in which the visit to the website is assigned to a default segment. For example, the segmentation module 120 may, at step 204, assign the visit of the first visitor 112 to the website 110 to a default segment. In at least some example embodiments, all qualified visits may at least initially be assigned to the default segment while the real-time behavior of the visitor during the visit is tracked.

The method 200 may next include one of steps 206, 208, or 210 in which the visit is assigned to a ‘low propensity to buy’ segment, a ‘needs help’ segment, or a ‘high propensity to buy segment, respectively. For example, after the real-time behavior of the visitor during the visit has been tracked, the segmentation module 120 may, at one of steps 206, 208, or 210, determine that the tracked real-time behavior corresponds to the low propensity to buy’ segment, the ‘needs help’ segment, or the high propensity to buy segment, at which point the segmentation module 120 may transfer the visit from the default segment to the appropriate visit-based segment. In this example, excluding visits assigned to the low propensity to buy' segment and the high propensity to buy segment may allow the method 200 to focus on those visits for which a website personalization, such as a chat conversation, can make the difference between no conversion event, such as a sale (and/or a small dollar sale) without a chat, and a successful conversion event, such as a sale (and/or a large dollar sale) with a chat.

The method 200 may next include one of steps 212, 214, or 216 in which the visit is assigned to an N/A group, a test group, or a control group, respectively. For example, after assigning the visit to the ‘needs help’ segment, the segmentation module 120 may, at one of steps 212, 214, or 216, further determine that the tracked real-time behavior corresponds to the N/A group, the test group, or the control group, at which point the segmentation module 120 may transfer the visit from the ‘needs help’ segment to the appropriate group. As disclosed in FIG. 2, about 75% of ‘needs help’ visits may be assigned to the test group while about 25% of the ‘needs help’ visits may be assigned to the control group. The N/A group is appropriate during periods of time where a desired web site personalization cannot be implemented due to lack of resources. For example, if a chat conversation is the desired website personalization but at a certain period of time there are no live agents available to chat, then the segmentation module 120 may, at step 212, determine that the lack of available live agents makes the N/A group appropriate for the visit. It is noted that certain website personalization, such as a chat with a live agents, may have a limited capacity and may occasionally cause a visit to fall within the N/A group while other website personalization, such as a computer-generated survey question, may have a virtually unlimited capacity and rarely if ever cause a visit to fall within the N/A group.

After the conclusion of step 212, 214, or 216, the web site 110 for the visits assigned to the test group may be altered by a website personalization and the website 110 for the visits assigned to the control group may not be altered by the website personalization. In this manner, the example method 200 may enable selective website personalization for multiple visitors exhibiting similar real-time behavior such that the outcomes of the similar visits can be compared in order to measure the impact of the website personalization on a conversion event of the website 110.

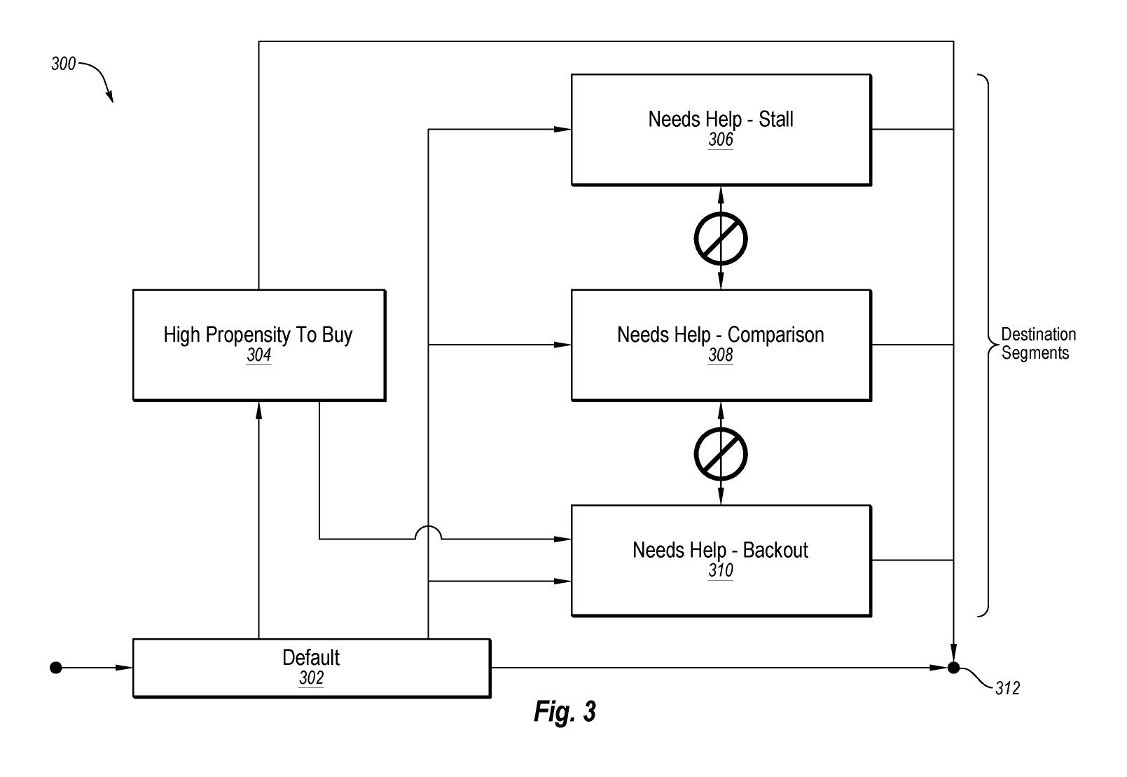

The method 300 disclosed in FIG. 3 is another example method of dynamic segmentation of website visits. The method 300 may include step 302 in which a visit to a website is assigned to a default segment. For example, the first visitor 112 may employ the browser 114 on the first computing device 102 to visit the website 110. Upon visiting the website 110, the segmentation module 120 may, at step 302, assign the visit of the first visitor 112 to the website 110 to a default segment while the real-time behavior of the first visitor 112 during the visit is tracked, in a manner similar to the assignment that occurs in step 204 of the method 200, discussed above.

The method 300 may next include one of steps 304, 306, 308, or 310 in which the visit is assigned to a ‘high propensity to buy’ segment, a ‘needs help—stall’ segment, a ‘needs help—comparison’ segment, or a ‘needs help—backout’ segment, respectively. For example, after the real-time behavior of the first visitor 112 during the visit has been tracked, the segmentation module 120 may, at one of steps 304, 306, 308, or 310, determine that the tracked real-time behavior corresponds to the ‘high propensity to buy’ segment, the ‘needs help—stall’ segment, the ‘needs help—comparison’ segment, or the ‘needs help—backout’ segment, at which point the segmentation module 120 may transfer the visit from the default segment to the appropriate visit-based segment. Taking the ‘needs help—comparison’ as an example, this segment may be considered appropriate where the tracked real-time behavior includes repeat interactions with page(s) of the website 110 during the visit, such as alternating interactions between a first page and a second page of the website 110 during the visit.

Continuing with the above example, where the visit has initially been assigned to the ‘high propensity to buy’ segment based on the tracked real-time behavior, the segmentation module 120 may later determine that the tracked real-time behavior of the first visitor 112 has changed such that the ‘needs help—backout’ segment has now become more appropriate for the visit than the initial ‘high propensity to buy’ segment. Where such a determination is made, the segmentation module 120 may transfer the visit from the ‘high propensity to buy’ segment to the ‘needs help—backout’ segment.

The method 300 may finally include step 312 in which the visit is concluded. For example, where the first visitor navigates the browser application 114 away from the web site 110, closes the browser application 114, or some predetermined period of time has elapsed since the beginning of the visit to the website 110, the segmentation module 120 may, at step 312, determine that the visit has concluded. The predetermined period of time may corresponds to an attribution window in which any conversion event that occurs during the predetermined period of time will be attributed to the website personalization that occurred during the initial visit to the website 110, even if the conversion event occurs during a subsequent visit that still falls within the attribution window.

Continuing with the above example, by the conclusion of step 312 the visits assigned to the ‘needs help’ segments will generally have been altered by a website personalization to account for the visitor's current needs and intentions during a particular visit to a website. Conversely, the visits assigned to the default and ‘high propensity to buy’ segments will not be altered by the website personalization to avoid distracting and frustrating the website visitor. In this manner, the example method 300 can employ visit-based dynamic segmentation to be more relevant and helpful to the website visitor 112 because it accounts for the current needs and intentions of the visitor 112 during a particular visit to the website 110.

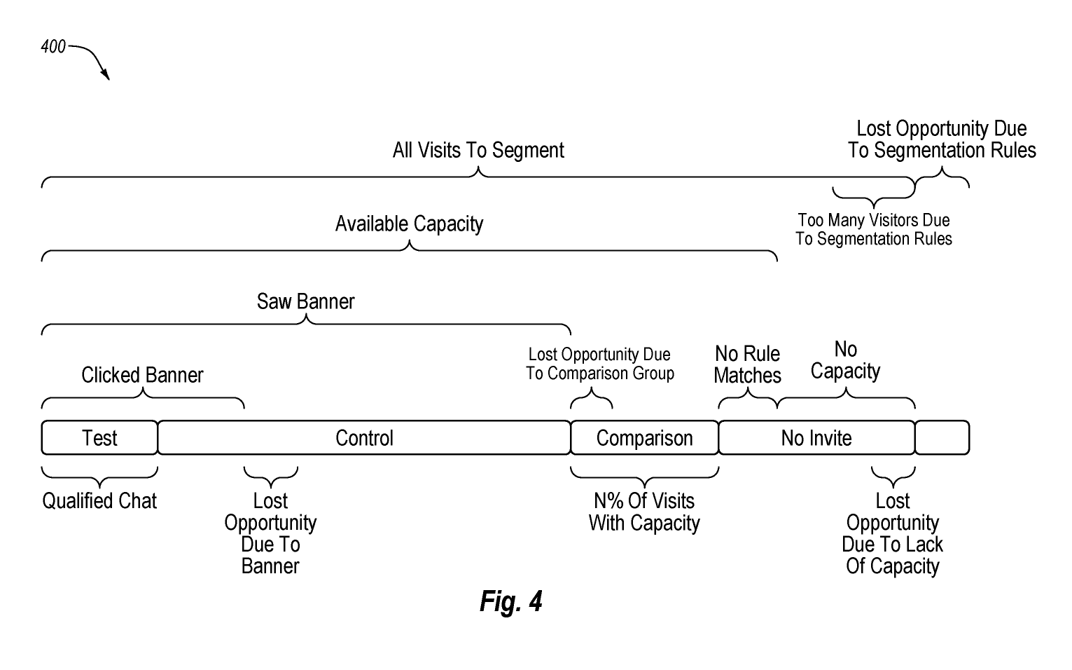

The method 400 disclosed in FIG. 4 is another example method of dynamic segmentation of website visits. The method 400 may include various steps in which visits to a website 110 are dynamically segmented based on real-time behavior of website visitors, and a portion of the segment is assigned to a test group in which a particular website personalization is presented, namely a chat conversation.

As disclosed in FIG. 4, the segment may either lose appropriate visits because the rules that determine whether a visit is assigned to the segment (the segmentation rules) are under inclusive or gain inappropriate visits because the segmentation rules are over inclusive. Also disclosed in FIG. 4, the available capacity for offering of chat conversations may further limit the number of visits assigned to the segment. The offering of chat conversations on the website 110 may be accomplished using a banner that is presented to the visitor on a webpage of the website 110. Of the visits where the banner is presented, some visits may be assigned to a test group, while other visits mays may be assigned to control and comparison groups.

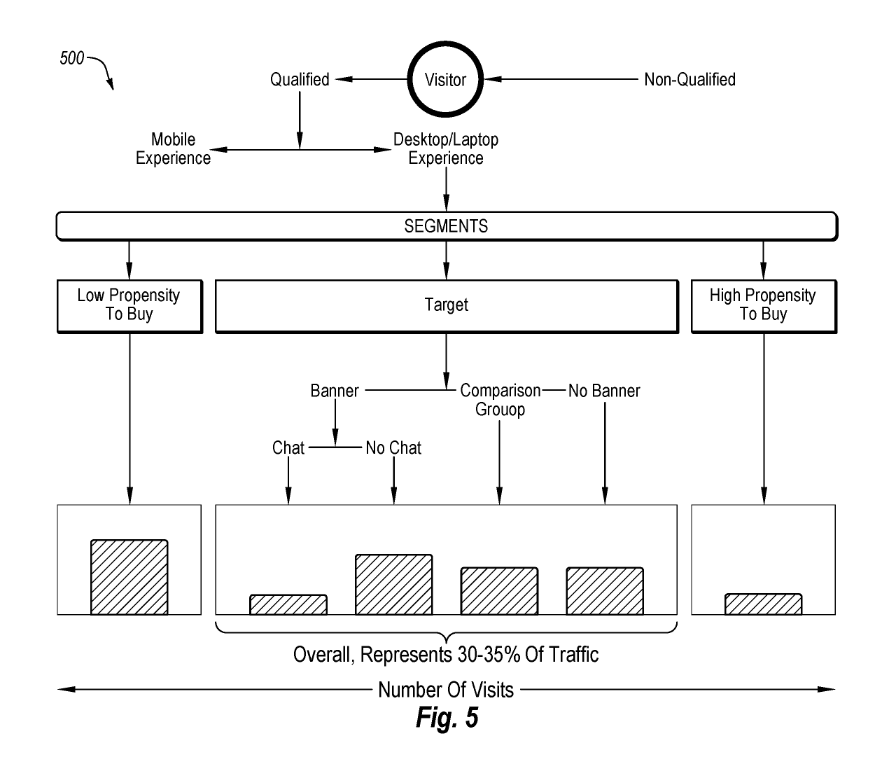

The method 500 disclosed in FIG. 5 is another example method of dynamic segmentation of website visits. The method 500 may include various steps in which visits to a website 110 are dynamically segmented based on real-time behavior of website visitors, and a portion of the segment is assigned to a test group in which a particular website personalization is presented, namely a chat conversation.

As disclosed in FIG. 5, the visit of a visitor may first be determined to be qualified or non-qualified. Next, an experience may be determined for the visit. For example, the experience of a visit may be determined based on the type of computing device that the visitor is employing during the visit to the website 110. For example, where the first computing device 102 employed by the first visitor 112 to visit the website 110 is a mobile computing device, the visit may be assigned to a mobile experience. Alternatively, where the first computing device 102 is a desktop or laptop computing device, the visit may be assigned to a desktop/laptop experience. Within the desktop/laptop experience, there may be a variety of segments which are generally divided into a low propensity to buy' segment, a ‘high propensity to buy’ segment, and a target segment. Visits assigned to the target segment may be further assigned to see a banner (which is either clicked on by the visitor resulting in a chat, or ignored by the visitor resulting in no chat), assigned to a comparison group, or assigned to not see a banner. In some embodiments, the segmentation rules may be formulated such that between about 30% and 35% of the visits to the website 110 are assigned to the target segment.

Accordingly, the methods 400 and 500 allow a chat conversation to be selectively offered during visits assigned to a particular segment. In this manner, the example methods 400 and 500 may enable selective chat conversations with multiple visitors exhibiting similar real-time behavior such that the outcomes of the similar visits can be compared in order to measure the impact of the chat conversations on a conversion event of the website 110.

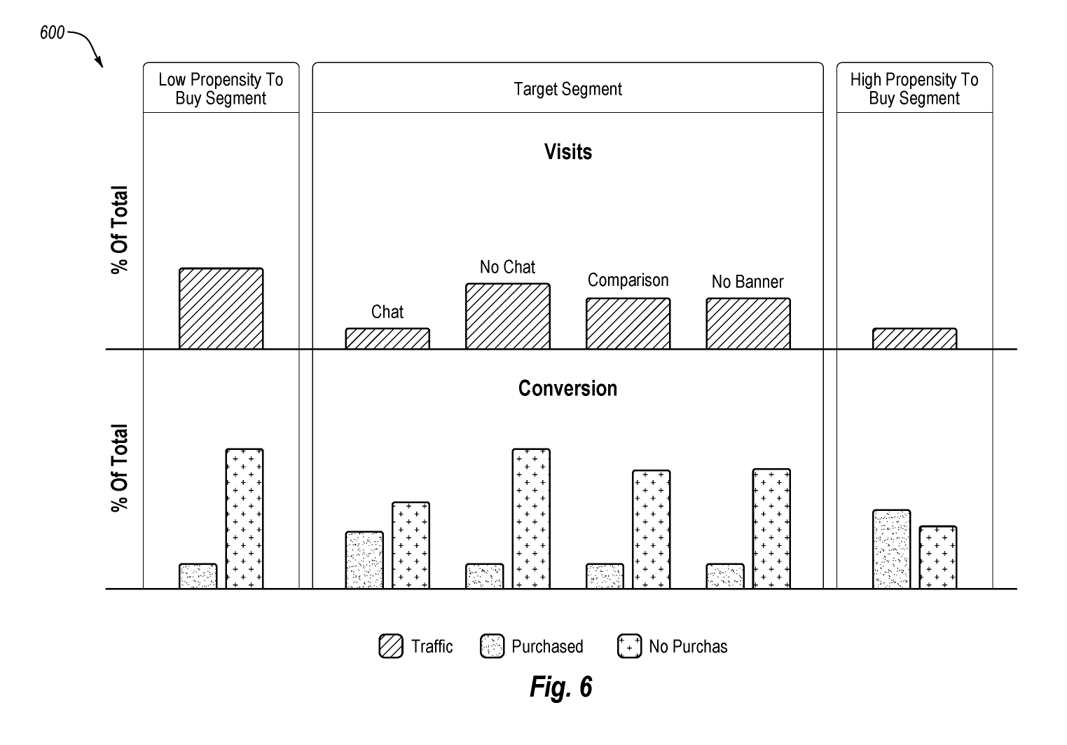

FIG. 6 is a chart 600 illustrating various website segments. As disclosed in FIG. 6, where the conversion event of interest is a purchase, the outcome of each visit to the web site can be categorized as either resulting in a purchase or resulting in no purchase. This categorization of outcomes may be useful in refining segmentation rules to ensure that the segmentation and accompanying chat conversations are properly formulated to increase sales on the website.

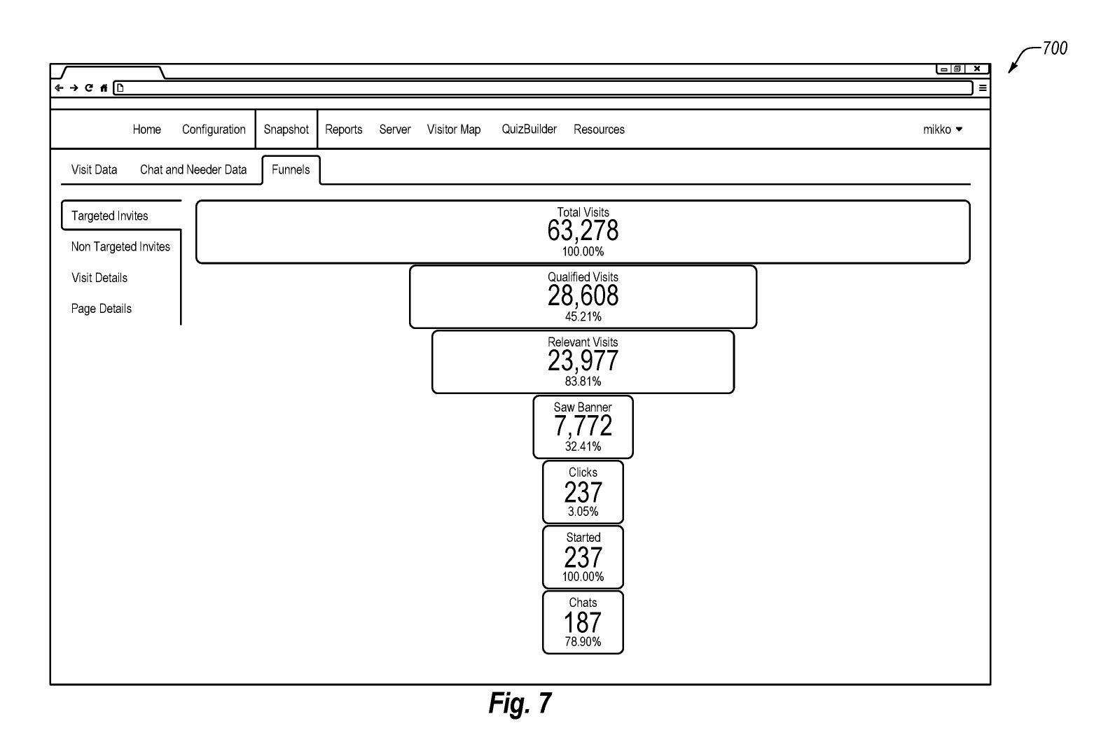

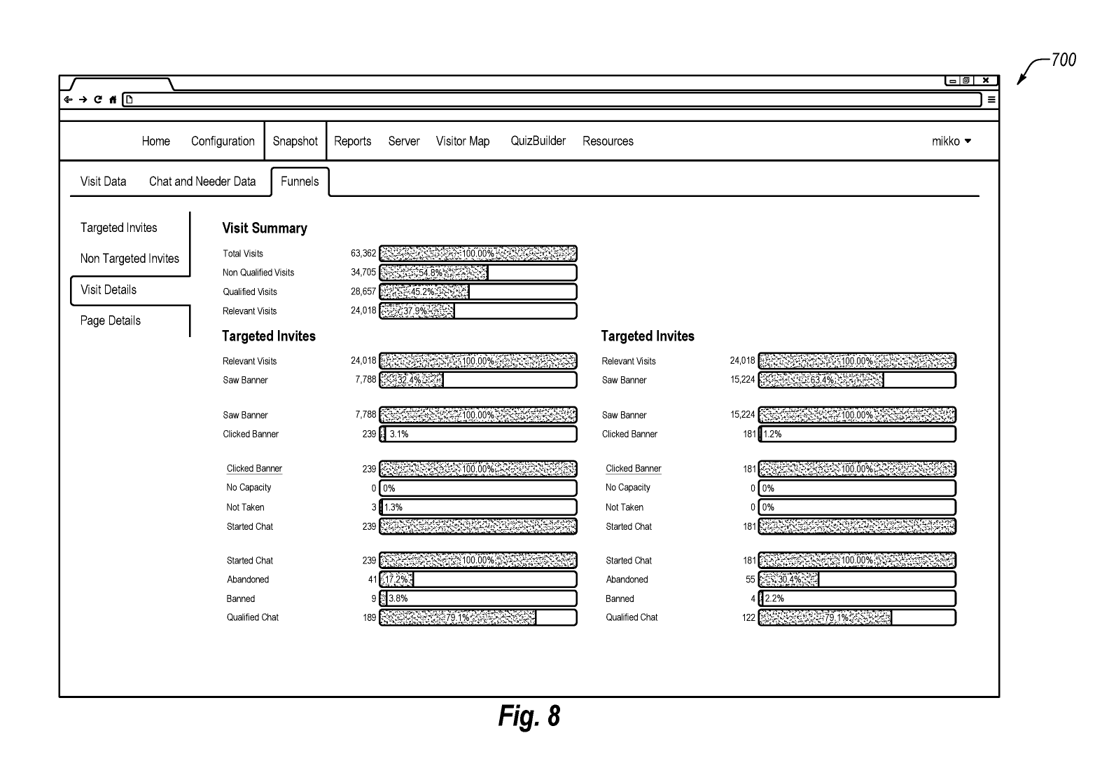

FIGS. 7 and 8 illustrate example computer screen images of a user interface 700 of an example dynamic segmentation system. The user interface 700 may be an administrative, backend system that the operator of the website 110 may use to track the outcome of the dynamic segmentation of visits and accompanying chat conversations on the website 110, and may be useful in refining segmentation rules to ensure that the segmentation and accompanying chat conversations are properly formulated to encourage a conversion event on the website 110, such as increased sales. As disclosed in FIG. 7, the user interface 700 includes a ‘targeted invites’ tab that reports on various segmentation-related statistics. For example, the ‘targeted invites’ tab displays the total number of visits to the website 110, the number of qualified visits, the number of relevant visits, the number of visits where an ‘invitation to chat’ banner was presented, the number of visits where the banner was clicked by the visitor, the number of chats that were started by the visitor, and the number of chats that were concluded by the visitor. As disclosed in FIG. 8, the user interface 700 may also include a ‘visit details’ tab that reports on various segmentation-related statistics.

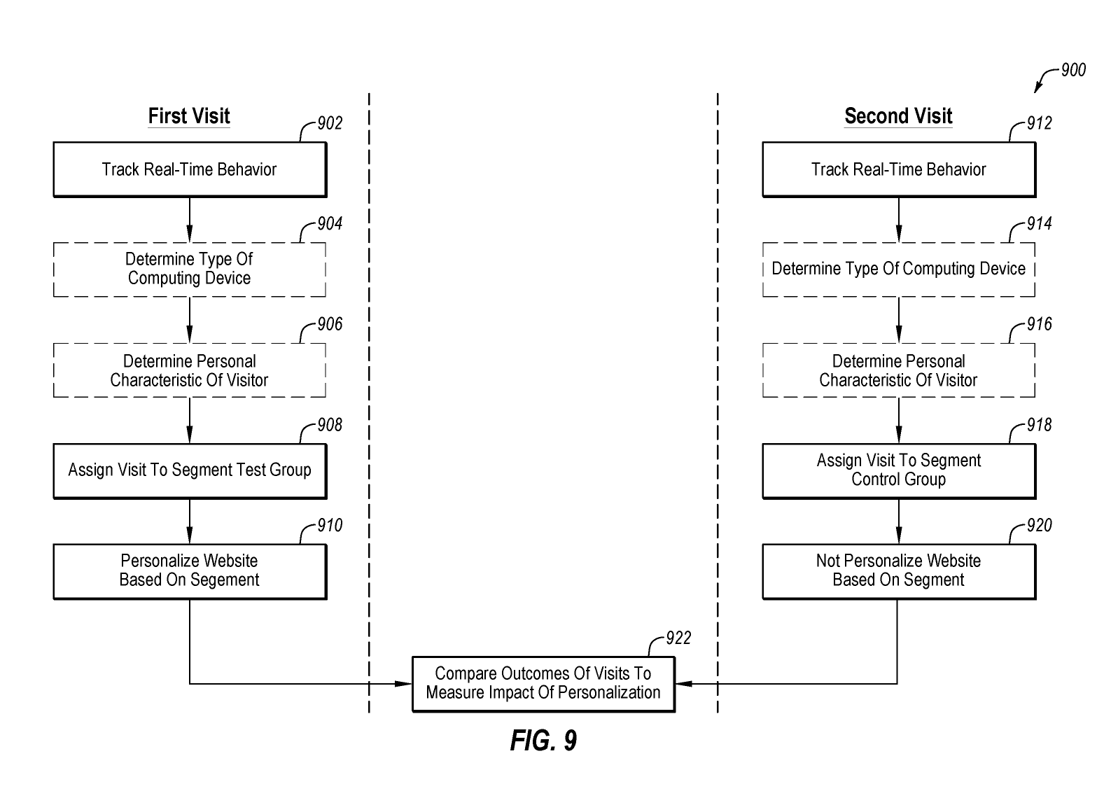

FIG. 9 is a schematic flowchart diagram of an example method 900 of dynamic segmentation of website visits. The methods 900 may be implemented, in at least some embodiments, by the segmentation module 120 of the example system 100 of FIG. 1. For example, the segmentation module 120 may be configured to execute computer instructions to perform operations of dynamic segmentation of visits to the website 110, as represented by one or more of the steps of the method 900. Although illustrated as discrete steps, various steps may be divided into additional steps, combined into fewer steps, or eliminated, depending on the desired implementation. The method 900 will now be discussed with reference to FIGS. 1 and 9.

The method 900 may include step 902 in which real-time behavior of a first visitor on a website is tracked during a visit to the website. For example, the first visitor 112 may employ the browser 114 on the first computing device 102 to visit the website 110. During the visit to the website 110, the segmentation module 120 may, at step 902, track the real-time behavior of the first visitor 112.

The method 900 may include an optional step 904 in which the type of computing device that the first visitor is employing during the visit to the website is determined. For example, the segmentation module 120 may, at optional step 904, determine the type of the first computing device 102 that is employed by the first visitor 112 to visit the website 110. This determined device type may then be employed to assign a visit to an experience prior to assigning the visit to a segment.

The method 900 may include an optional step 906 in which a personal characteristic of the first visitor is determined. For example, the segmentation module 120 may, at optional step 906, determine a personal characteristic of the first visitor 112. The personal characteristic may include, for example: past visits of the first visitor 112 to the website 110, past conversion events of the first visitor 112 on the website 110, a physical geographical location of the first visitor 112, or some combination thereof. This determined personal characteristic may then be employed to assign a visit to an experience prior to assigning the visit to a segment.

The method 900 may include a step 908 in which the visit of the first visitor is assigned to a test group of the corresponding segment. For example, the segmentation module 120 may determine, at step 908, that the tracked real-time behavior of the first visitor 112 corresponds to a particular one of multiple segments. For example, where the first visitor 112 quickly finds a product and adds the product to a shopping cart of the website 110, but then instead of purchasing the product in the shopping cart, leaves the shopping cart to continue shopping by searching for another similar product, the segmentation module 120 may determine that this this tracked real-time behavior corresponds to the ‘needs help—backout’ segment disclosed in FIG. 3. Accordingly, the segmentation module 120 may, at step 908, assign the visit of the first visitor 112 to a test group, as disclosed in FIG. 2, of the ‘needs help—backout’ segment of FIG. 3.

The method 900 may include a step 910 in which the website is personalized during the visit of the first visitor based on the corresponding segment. For example, the segmentation module 120 may, at step 910, personalize the website 110 during the visit of the first visitor 112 to the website 110 by displaying a banner on a webpage of the website 110 that invites the first visitor 112 to chat with the agent 122 of the website 110. Where the visit has been assigned to the ‘needs help—backout’ segment, the agent 122 may attempt to engage the visitor 112 in a chat to help resolve whatever concern is preventing the visitor 112 from completing the purchase of the product in the shopping cart.

The method 900 may include step 912, 914, 916, and 918, which are similar to steps 902, 904, 906, and 908, respectively, except that the visitor being tracked is a second visitor such as the second visitor 116, the computing device that is employed is a second computing device such as the second computing device 118, and the second visitor is assigned to a control group of the segment instead the test group, such as the control group of the “needs help—backout” target segment, as disclosed in FIGS. 2 and 3.

The method 900 may include a step 920 in which the website is not personalized during the visit of the second visitor based on the corresponding segment. For example, the segmentation module 120 may, at step 920, not personalize the website 110 during the visit of the second visitor 116 to the website 110 by not displaying an ‘invitation to chat’ banner on a webpage of the website 110.

The method 900 may include a step 922 in which the outcomes of the visit of the first visitor and the visit of the second visitor are compared to measure the impact of the website personalization on a conversion event of the website. For example, the segmentation module 120 may, at step 922, compare the outcomes of the visit of the first visitor 112 and the visit of the second visitor 116 to measure the impact of the chat conversation on purchases made on the website 110. These outcomes may be compared because the visit of the first visitor 112 and the visit of the second visitor 116 were both assigned to the same segment. Further, in order to be assigned to the same segment, these visits may also have been assigned to the same experience, either based on a determination that the computing device 102 employed by the first visitor 112 and the computing device 104 employed by the second visitor 116 are of the same type or based on a determination that the determined personal characteristic of the first visitor 112 and the determined personal characteristic of the second visitor 116 are of the same classification. For example, where a physical geographic location of the first visitor 116 is determined to be in the same classification as a physical geographic location of the second visitor 116 (such as both being within a predetermined geographic boundary or within a predetermined distance from one another), then the visits of the first visitor 112 and the second visitor 116 may be assigned to the same experience. By being assigned to the same experience, the visits may also later be assigned to the same segment, as disclosed in FIG. 5. The comparison of outcomes may be used to demonstrate that chat conversations resulted in increased sales (i.e. new net revenue), increased purchase amounts (i.e. higher average purchase amount for sales), and/or greater customer satisfaction, for example. The ability to demonstrate the value of chat conversation may be useful when selling the service of providing the chat conversation to an operator of an online retailer website, for example.

The embodiments described herein may include the use of a special-purpose or general-purpose computer including various computer hardware or software modules or filters, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general-purpose computer, special-purpose computer, or virtual computer such as a virtual machine. Combinations of the above may also be included within the scope of computer-readable media.

Computer-executable instructions comprise, for example, instructions and data which cause a general-purpose computer, special-purpose computer, or virtual computer such as a virtual machine to perform a certain function or group of functions. Although the subject matter has been described in language specific to structural features and/or methodological steps, it is to be understood that the subject matter defined in the appended claims is not necessarily limited to the specific features or steps described above. Rather, the specific features and steps described above are disclosed as example forms of implementing the claims.

As used herein, the term “module” may refer to software objects or routines that execute on a computing system. The different modules described herein may be implemented as objects or processes that execute on a computing system (e.g., as separate threads). While the system and methods described herein are preferably implemented in software, implementations in hardware or a combination of software and hardware are also possible and contemplated.

All examples and conditional language recited herein are intended for pedagogical objects to aid the reader in understanding the example embodiments and the concepts contributed by the inventor to furthering the art, and are to be construed as being without limitation to such specifically-recited examples and conditions.

1-10. (canceled)

11. A method of website personalization based on real-time visitor behavior, the method comprising:
tracking real-time behavior of a first visitor on a website during a visit to the website, the first visitor employing a first computing device to visit the website;
tracking real-time behavior of a second visitor on the website during a visit to the website, the second visitor employing a second computing device to visit the website;
determining that the visit of the first visitor and the visit of the second visitor both correspond to a particular one of multiple visit-based segments based on the first visitor's tracked real-time behavior and the second visitor's tracked real-time behavior and without regard to any previous behavior of the first visitor that occurred previous to the visit of the first visitor and without regard to any previous behavior of the second visitor that occurred previous to the visit of the second visitor;
assigning the visit of the first visitor to a test group of the particular visit-based segment, the test group being targeted for website personalization;
personalizing, by a web server that hosts the website, the website as presented at the first computing device during the visit of the first visitor based on the particular visit-based segment by presenting a selectable webpage element on the website that invites the first visitor to a chat conversation between a human agent of the website and the first visitor;
assigning the visit of the second visitor to a control group of the particular visit-based segment, the control group not being targeted for website personalization;
not personalizing, by the web server, the website as presented at the second computing device during the visit of the second visitor by not presenting a selectable webpage element on the website that invites the second visitor to a chat conversation between a human agent of the website and the second visitor; and
comparing outcomes of the visit of the first visitor and the visit of the second visitor to measure an impact of the website personalization on a conversion event of the website.

12. The method as recited in claim 11, wherein the real-time behavior of the first visitor or the second visitor includes the visitor adding an item to a shopping cart of the website and then leaving the shopping cart to continue shopping.

13. The method as recited in claim 11, wherein the real-time behavior of the first visitor or the second visitor includes alternating interactions between a first page and a second page of the website during the visit.

14. The method as recited in claim 11, wherein the real-time behavior of the first visitor or the second visitor includes how long each page of the website has focus during the visit.

15. The method as recited in claim 11, wherein the real-time behavior of the first visitor or the second visitor includes a number of tabs in a browser that the visitor has open during the visit.

16. The method as recited in claim 11, wherein the conversion event includes:
a sale of an item to the first visitor;
a subscription by the first visitor;
a donation by the first visitor;
submission of personal information by the first visitor; or
some combination thereof.

17. The method as recited in claim 11, wherein:
the tracking the real-time behavior of the first visitor on the website includes determining a type of the first computing device that the first visitor is employing during the visit to the website;
the tracking the real-time behavior of the second visitor on the website includes determining a type of the second computing device that the second visitor is employing during the visit to the website; and
the determining that the visit of the first visitor and the visit of the second visitor both correspond to the particular visit-based segment includes determining that the first computing device employed by the first visitor and the second computing device employed by the second visitor are of the same type.

18. The method as recited in claim 11, wherein:
the tracking the real-time behavior of the first visitor on the website includes determining a personal characteristic of the first visitor;
the tracking the real-time behavior of the second visitor on the website includes determining a personal characteristic of the second visitor; and
the determining that the first visitor's tracked real-time behavior and the second visitor's tracked real-time behavior correspond to the particular visit-based segment includes determining that the determined personal characteristic of the first visitor and the determined personal characteristic of the second visitor are of the same classification.

19. The method as recited in claim 11, wherein:
the website is an online retailer website;
the determining that the visit of the first visitor and the visit of the second visitor both correspond to the particular visit-based segment includes determining that the first visitor's tracked real-time behavior and the second visitor's tracked real-time behavior both correspond to a target visit-based segment based on each of the first visitor's tracked real-time behavior on the online retailer website and the second visitor's tracked real-time behavior on the online retailer website indicating that the corresponding visitor currently has a propensity to make a purchase on the online retailer web site that is within a predetermined range of propensities; and
the conversion event is a purchase on the online retailer website.

20. One or more non-transitory computer-readable media storing one or more programs that causes one or more processors to execute the method as recited in claim 11.

21. A method of website personalization based on real-time visitor behavior, the method comprising:
tracking real-time behavior of a first visitor on an online retailer website during a visit to the online retailer website, the first visitor employing a first browser application on a first computing device to visit the online retailer website;
tracking real-time behavior of a second visitor on the online retailer website during a visit to the online retailer website, the second visitor employing a second browser application on a second computing device to visit the online retailer website;
determining that the visit of the first visitor and the visit of the second visitor both correspond to a particular one of multiple visit-based segments based on the first visitor's tracked real-time behavior on the online retailer website and the second visitor's tracked real-time behavior on the online retailer website indicating that the corresponding visitor currently has a propensity to make a purchase on the online retailer website that is within a predetermined range of propensities and without regard to any previous behavior of the first visitor that occurred previous to the visit of the first visitor and without regard to any previous behavior of the second visitor that occurred previous to the visit of the second visitor;
assigning the visit of the first visitor to a test group of the particular visit-based segment, the test group being targeted for website personalization;
personalizing, by a web server that hosts the online retailer website, the online retailer website as presented at the first computing device during the visit of the first visitor based on the particular visit-based segment by presenting a selectable webpage element on the online retailer website that invites the first visitor to a chat conversation between a human agent of the online retailer website and the first visitor;
assigning the visit of the second visitor to a control group of the particular visit-based segment, the control group not being targeted for website personalization;
not personalizing, by the web server, the online retailer website as presented at the second computing device during the visit of the second visitor by not presenting a selectable webpage element on the online retailer website that invites the second visitor to a chat conversation between a human agent of the online retailer website and the second visitor; and
comparing outcomes of the visit of the first visitor and the visit of the second visitor to measure an impact of the website personalization on a purchase made on the online retailer website.

22. The method as recited in claim 21, wherein the real-time behavior of the first visitor or the second visitor includes the visitor adding an item to a shopping cart of the website and then leaving the shopping cart to continue shopping.

23. The method as recited in claim 21, wherein the real-time behavior of the first visitor or the second visitor includes alternating interactions between a first page and a second page of the website during the visit.

24. The method as recited in claim 21, wherein the real-time behavior of the first visitor or the second visitor includes how long each page of the website has focus during the visit.

25. The method as recited in claim 21, wherein the real-time behavior of the first visitor or the second visitor includes a number of tabs in the corresponding browser application that the visitor has open during the visit.

26. The method as recited in claim 21, wherein:
the tracking the real-time behavior of the first visitor on the website includes determining a type of the first computing device that the first visitor is employing during the visit to the website;
the tracking the real-time behavior of the second visitor on the website includes determining a type of the second computing device that the second visitor is employing during the visit to the website; and
the determining that the visit of the first visitor and the visit of the second visitor both correspond to the particular visit-based segment includes determining that the first computing device employed by the first visitor and the second computing device employed by the second visitor are of the same type.

27. The method as recited in claim 21, wherein:
the tracking the real-time behavior of the first visitor on the website includes determining a personal characteristic of the first visitor;
the tracking the real-time behavior of the second visitor on the website includes determining a personal characteristic of the second visitor; and
the determining that the first visitor's tracked real-time behavior and the second visitor's tracked real-time behavior correspond to the particular visit-based segment includes determining that the determined personal characteristic of the first visitor and the determined personal characteristic of the second visitor are of the same classification.

28. The method as recited in claim 27, wherein:
the personal characteristic of the visitor includes a physical geographical location of the visitor; and
the determining that the determined physical geographical location of the first visitor and the determined physical geographical location of the second visitor are of the same classification includes determining that the determined physical geographical location of the first visitor and the determined physical geographical location of the second visitor are both within a predetermined geographic boundary.

29. The method as recited in claim 27, wherein:
the personal characteristic of the visitor includes a physical geographical location of the visitor; and
the determining that the determined physical geographical location of the first visitor and the determined physical geographical location of the second visitor are of the same classification includes determining that the determined physical geographical location of the first visitor and the determined physical geographical location of the second visitor are within a predetermined distance from one another.

30. One or more non-transitory computer-readable media storing one or more programs that causes one or more processors to execute the method as recited in claim 21.
